(19) United States
(12) Patent Application Publication
(10) Pub. No.: US 2006/0082152 A1
(43) Pub. Date: Apr. 20, 2006

(54) Auto-release coupling head

(76) Inventor: John Anthony Neves, Okotoks (CA)

Correspondence Address: DIEDERIKS & WHITELAW, PLC, 12471 Dillingham Square, #301, Woodbridge, VA, 22192, US

(21) Appl. No.: 11/225,166

(22) Filed: Sep. 14, 2005

(30) Foreign Application Priority Data
Sep. 14, 2004 (CA) 2,481,601

(51) Int. Cl. F16L 21/06

(52) U.S. Cl. 285/322

(57) ABSTRACT

A coupling device is described in which a connector is attached to each device to be coupled. The connectors are attached by way of collet fingers biased into recesses within the opposing connector by a slideable collar. The slideable collar may be locked into a coupling position by a locking mechanism such as a setscrew. To release the locking mechanism, a fluid pressure is applied to overcome the locking mechanism and drive apart the connectors.

### CROSS REFERENCE TO RELATED APPLICATIONS

This application claims the benefit of Canadian Application No. 2,481,601. filed Sep. 14, 2004, which is incorporated herein by reference.

### FIELD OF THE INVENTION

The present invention relates generally to coupling devices. More particularly, the present invention relates to a coupling device that can be readily decoupled upon application of minimal force to the coupling device, and which uses the decoupling force to forcibly disconnect the previously coupled parts.

### BACKGROUND OF THE INVENTION

Mechanical coupling devices are well known and are used for a variety of purposes. In many instances, secure engagement or coupling of two or more devices may be required; however, the coupling must also be readily or forcibly detachable upon application of external force. An example of this need is found in the field of explosive wellbore perforation, in which a perforating gun is lowered into a production well cased by a wellbore. After the gun is detonated to perforate the wellbore, oil and gas production is initiated, and continued presence of the expended gun within the perforated well would be a liability, so it must be decoupled from the tubing string or removed. Removal is sometimes impossible or extremely difficult or expensive.

Separation devices have therefore been specifically developed for the oil and gas industry to separate the gun from the tubing string. The separation device releases the perforating gun upon detonation of the explosive perforating charge, and the gun falls to the bottom of the wellbore so as not to interfere with production at the perforated location. For example, the present inventor has described in previous patent applications (see CA 2,470,559 and CA 2,470,562) firing heads of this type which may be used to initiate the detonation of a well-perforating charge, while simultaneously or subsequently triggering release of the gun from the tubing assembly.

Although such purpose-built firing heads have potential in the field of well perforation, they are not necessarily useful for other decoupling applications. In the field of coupling devices in general, the force supportable by a coupling device is generally limited by the amount of force available to secure the coupling device in the coupled position. Therefore, a coupling device that can support a large coupling force or weight, but can be readily decoupled with minimal force or effort, would find use in many applications.

Moreover, the portion of a coupling device which bears the coupling force may be subject to wear, or to accidental decoupling. Failure of a coupling device can have disastrous consequences in certain applications, such as in the coupling of rail cars or the lifting of heavy objects.

It is, therefore, desirable to provide a coupling device that can be used in various applications and will reliably support a large load, but can be readily and reliably decoupled as necessary with minimal external force.

### SUMMARY OF THE INVENTION

It is an object of the present invention to obviate or mitigate at least one disadvantage of previous coupling devices.

In one aspect, the present invention is a coupling device having first and second connectors each attachable to an item to be coupled, the first connector including a collet engageable within a housing having collet finger recesses, the housing operatively attached to the second connector; a collar slideably engaged within the housing, the collar slideable between a locked position in which the collar holds the collet into locking engagement with the recesses, and a release position in which the collet fingers are not held into such engagement; and a releasable lock for maintaining the collar in the locked position until the collar is released.

Preferably, the locking system can be overcome by application of pressure to the collar which is then permitted to slide into the release position. Preferably, continued application of pressure to the collar when released, causes the first and second connectors to be driven apart. Preferably, the housing includes a passage whereby fluid pressure can be applied to the collar to release the locking system, thereby sliding the collar from the locked position to the release position. Preferably, continued fluid pressure applied to the passage causes the first and second connectors to be driven apart. Preferably, the passage is continuous with a pressure chamber in the first connector, and wherein the fluid pressure is applied to the passage by way of the pressure chamber. Preferably, continued fluid pressure applied to the pressure chamber causes the first and second connectors to be driven apart. Preferably, the coupling device further includes a piston adjacent the pressure chamber and extending through the housing, collet, and collar. Preferably, the piston, when driven towards the first connector, applies pressure to the pressure chamber, thereby applying pressure to the passage and to the collar to drive the collar from the locking position and driving the first and second connectors apart. Preferably, the piston provides a second passage, through which the fluid pressure is applied to pressure chamber and the first passage. Preferably, the releasable lock is a shear pin held in place by a setscrew.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a longitudinal cross sectional view of a coupling device in accordance with an embodiment of the invention when the collar is in a locked position;

FIG. 2 is a longitudinal cross sectional view of a coupling device in accordance with an embodiment of the invention in which the piston is not hollow or perforated;

FIG. 3 is a longitudinal cross sectional view of a coupling device in accordance with an embodiment of the invention in which a piston is not present;

FIG. 4 is an engineering drawing of an embodiment of the invention;

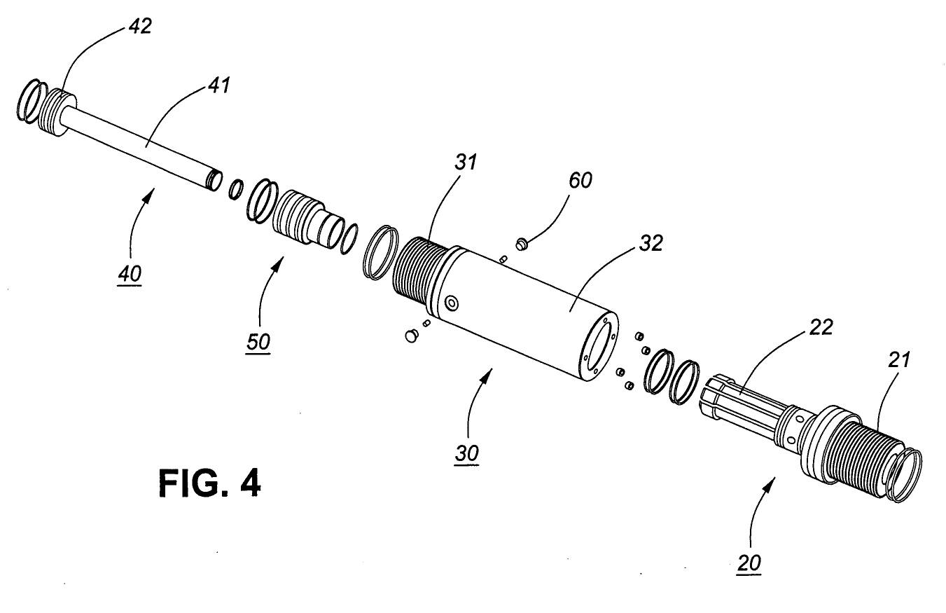

FIG. 5 is an engineering drawing of an embodiment of the invention;

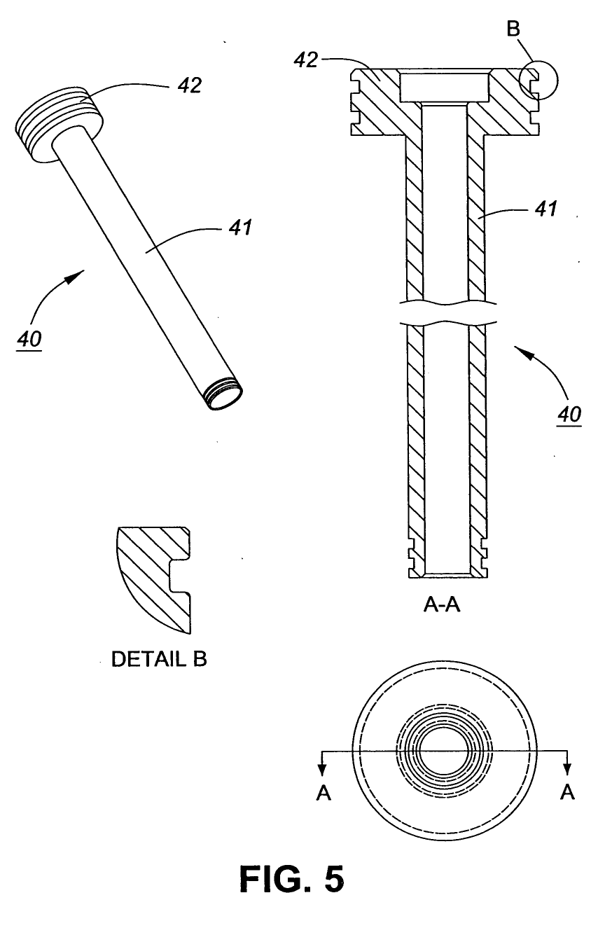

FIG. 6 is an engineering drawing of an embodiment of the invention;

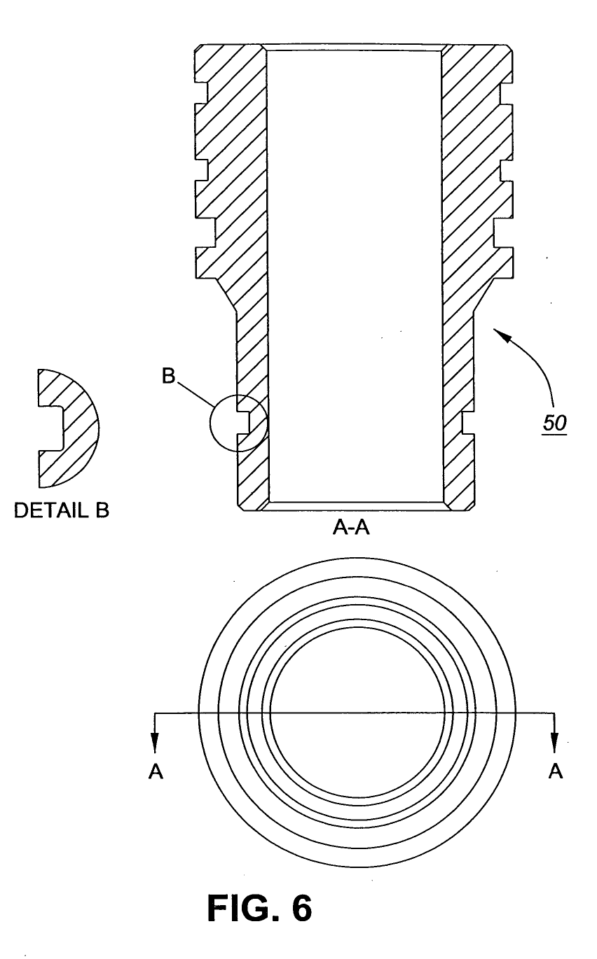

FIG. 7 is an engineering drawing of an embodiment of the invention; and

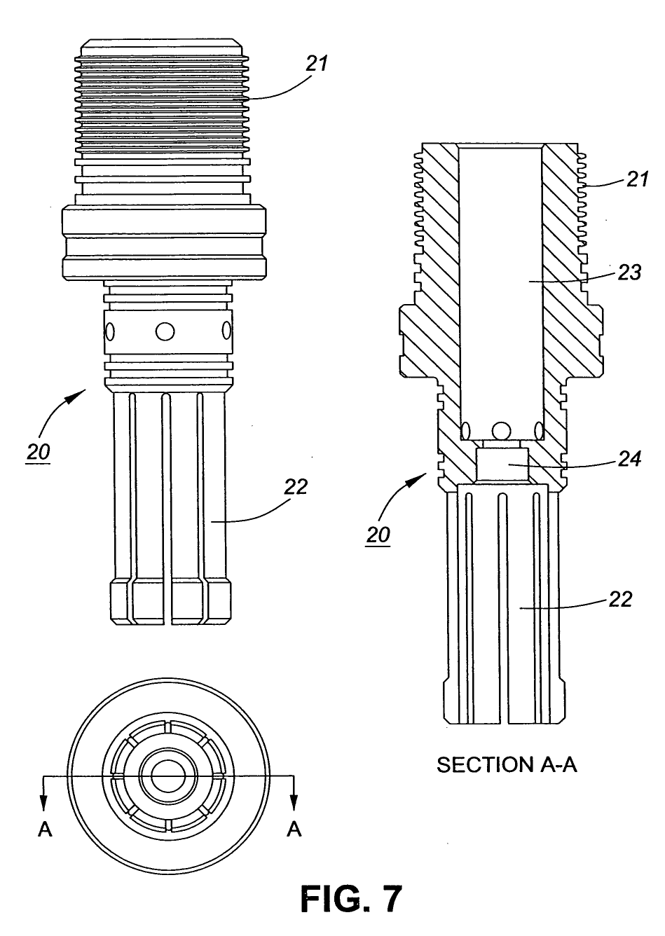

FIG. 8 is an engineering drawing of an embodiment of the invention.

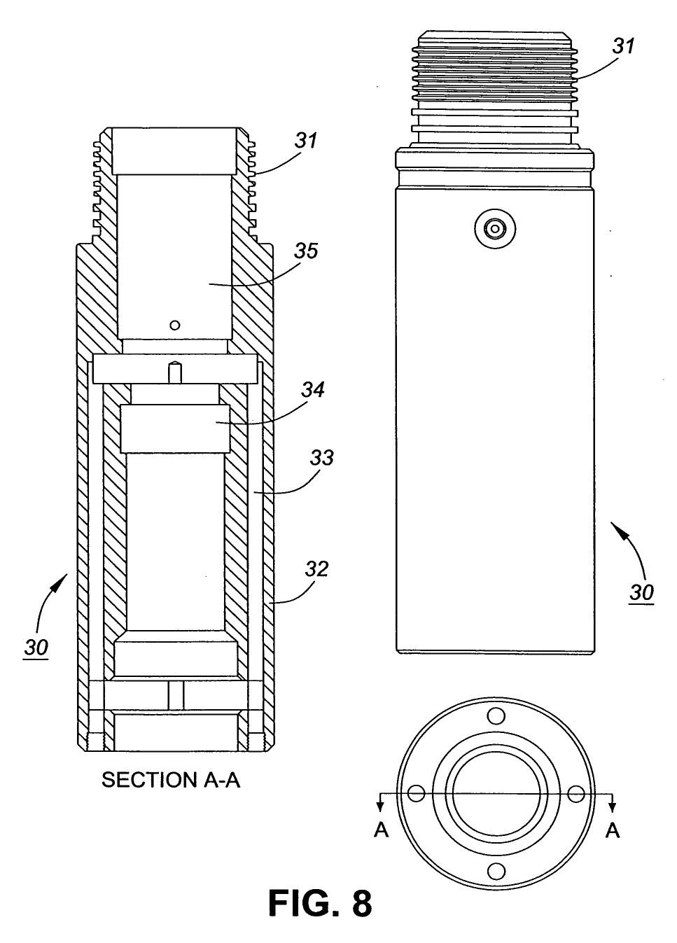

### DETAILED DESCRIPTION

Generally, the present invention provides a coupling device. The coupling device is particularly suited for use with downhole equipment, but has other potential applications, as will be apparent to the reader.

Structure of the Coupling Device

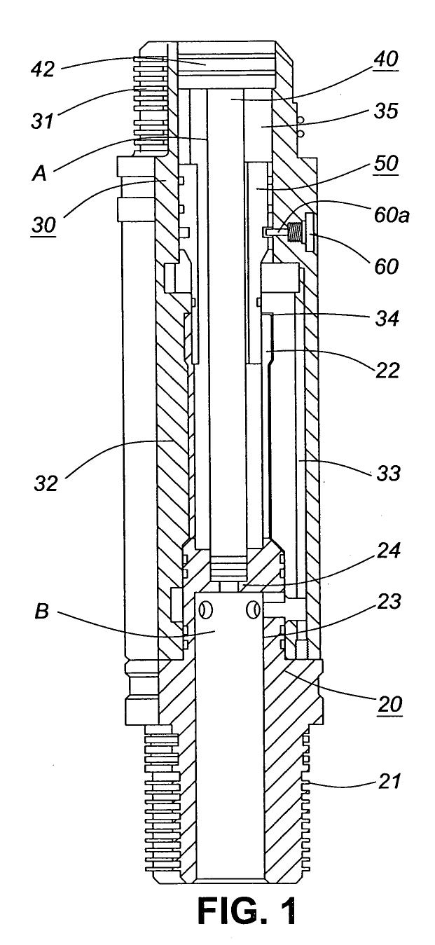

With reference to FIG. 1, an embodiment of the coupling device includes first and second connectors 20, 30. Each connector includes threaded ends 21, 31, or is otherwise attachable to a device to be coupled. In a preferred embodiment, the first connector may be attached to a perforating gun to be lowered downhole into a wellbore, while the second connector may be attached to a tubing string or wireline for delivering, locating, and initiating detonation of the gun's charge.

The first connector 20 includes a threaded attachment end 21, collet fingers 22, a pressure chamber 23, and an optional piston stop 24. The second connector 30 includes a threaded attachment end 31, a housing 32 having a passageway 33, collet recesses 34, and a central bore 35. The coupling device also includes a hollow piston (otherwise known as a snorkel tube) 40 and a collar 50.

When the coupling device is assembled and locked into the coupled position, the collet fingers 22 of the first connector 20 are biased into the collet recesses 34 of the housing 32 by the position of the collar 50, which is secured in place by setscrew 60, which secures a brass or aluminum shear pin 60a. The piston extends within the central bore 35 of the housing 32, to abut the optional piston stop 24 of the first connector.

Notably, in the assembled coupling, there are two distinct regions of isolated pressure. A pressure-containing volume A exists surrounding the piston rod 41 between the piston head 41 and the collar 50. Both the collar 50 and the piston head 41 preferably include seals to isolate this region A. A second pressure-containing volume B includes the pressure chamber 23, the passageway 33, and the regions within the piston rod 41 and above the piston head 42. This second region B, may be pressurized, however, the pressure of region B must not overcome the pressure exerted by the setscrew 60 to retain the collar 50 in the locked position, while the device is locked.

Uncoupling/Release

In order to unlock the collar 50, the pressure of volume B must increase to overcome the force of the shear pin 60a. This can be accomplished, for example, by applying a fluid pressure to the region above the piston head 42, or to the pressure chamber 23 or the passageway 33. Once the pressure of region B overcomes the restraint exerted by the set screw 60 typically by shearing the shear pin 60a, the collar 50 will be driven towards the piston head 42, releasing the biasing pressure against the collet fingers 22. The collet fingers 22 will be capable of being forced from the recesses by the pulling force of the first connector and the pressure exerted by region A, and in addition, region B will now be extended to surround the piston rod 41 below the collar, exerting a downward pressure against the first connector, driving it from the second connector. The previously coupled devices will have thereby been uncoupled.

In the example of the perforating gun, application of pressure above the piston head 42 will increase the pressure of region B, causing detonation of the gun at the detonator (not shown). The gun will return exhaust gas to the pressure chamber 23, which will be conveyed through the passageway 33 and will displace the collar 50. The perforating gun will then be driven from the second connector, which remains attached to the tubing string.

Notably, the collar 50 and piston 40 remain within the second connector due to the shape of the central bore 35, and can be used again with another perforating gun and another first connector 20. Alternatively, the collar 50 and piston 40 may be releasable from the second connector depending on the shape of the central bore 35.

Collet

The collet may be a single collet ring, an arcuate collet finger or a plurality of collet fingers. The inventor has found that for downhole coupling or other vertical coupling applications, it is preferred that the fingers be chamfered to about 30 degrees. A taper of 45 degrees or greater results in binding, excessive friction and poor release of the collet fingers when heavy loads are used. When a 15-degree or smaller chamfer is used, the collet fingers may fail or deform themselves or the collar, and release prematurely. Similarly, the recesses may be shaped with 90-degree angles, or may be tapered as necessary to accommodate other release conditions.

Alternative Configurations

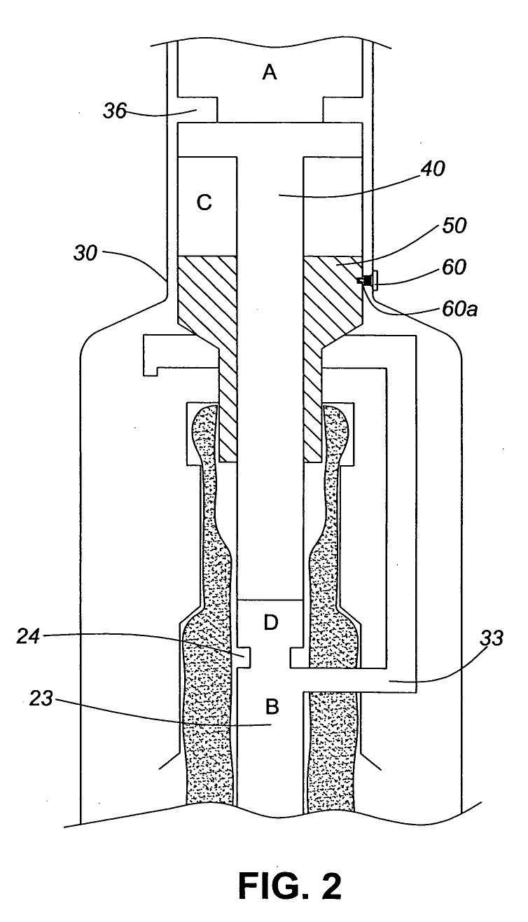

As shown in FIG. 2, a coupling device in accordance with the invention may include a piston 40 which is solid, not having a through bore. In this example, the space C above the collar 50 would be increased such that the higher-pressure region B would exert an upward pressure upon the piston 40, creating a space D below the piston rod 41 and above the piston stop 24. An additional piston head stop 36 may be included within the second connector 30 to ensure that space C is larger than space D. To uncouple the device, a pressure would be applied to the piston to drive it towards the piston stop 24, thereby displacing fluid from space D and increasing the pressure of region B such that the retention force of the set screw is overcome. Alternatively, pressure could be applied directly to region B (either to the pressure chamber 23 or to the passageway 33, in which case the piston 40, would not be not required.

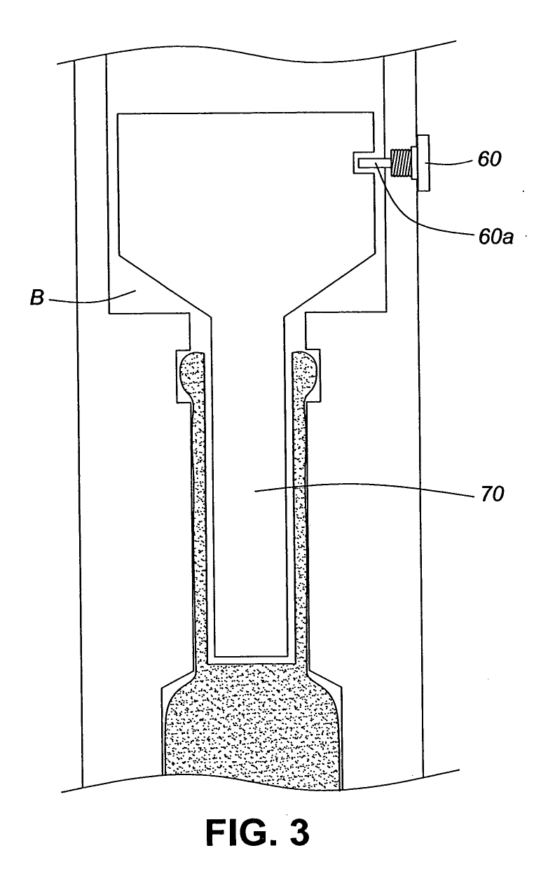

In a further embodiment, as shown in FIG. 3, the piston and collar could be replaced with a plug 70. In this embodiment, the collet fingers are held directly in place by the plug 70, and region B is greatly reduced, as shown. Application of pressure to region B would overcome the setscrew, and lift the plug from biasing the collet fingers. Again, the pressure below the plug (in expanded region B) would continue to increase, driving the first and second connectors apart.

The device can be configured to release a coupled load from a hanger, as when explosive devices are drop-tested by being suspended a known height from a hard surface and then remotely released.

It is apparent from the above description that many embodiments are possible, and many modifications could be made to the basic structure to suit a given coupling need. The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A coupling device comprising: first and second connectors each attachable to an item to be coupled, the first connector including a collet engageable within a housing having collet finger recesses, the housing operatively attached to the second connector; a collar slideably engaged within the housing, the collar slideable between a locked position in which the collar holds the collet into locking engagement with the recesses, and a release position in which the collet fingers are not held into such engagement; and a releasable lock for maintaining the collar in the locked position until the collar is released.

2. The coupling device of claim 1 whereby the locking system can be overcome by application of pressure to the collar which is then permitted to slide into the release position.

3. The coupling device of claim 2 whereby continued application of pressure to the collar when released, causes the first and second connectors to be driven apart.

4. The coupling device of claim 1 wherein the housing includes a passage whereby fluid pressure can be applied to the collar to release the locking system, thereby sliding the collar from the locked position to the release position.

5. The coupling device of claim 4 whereby continued fluid pressure applied to the passage causes the first and second connectors to be driven apart.

6. The coupling device of claim 4 wherein the passage is continuous with a pressure chamber in the first connector, and wherein the fluid pressure is applied to the passage by way of the pressure chamber.

7. The coupling device of claim 6 whereby continued fluid pressure applied to the pressure chamber causes the first and second connectors to be driven apart.

8. The coupling device of claim 6 further comprising a piston adjacent the pressure chamber and extending through the housing, collet, and collar.

9. The coupling device of claim 8 whereby the piston, when driven towards the first connector, applies pressure to the pressure chamber, thereby applying pressure to the passage and to the collar to drive the collar from the locking position and driving the first and second connectors apart.

10. The coupling device of claim 8 wherein the piston provides a second passage, through which the fluid pressure is applied to pressure chamber and the first passage.

11. The coupling device of claim 1 wherein the releasable lock is a shear pin held in place by a setscrew.
